(19) United States
(12) Patent Application Publication
(10) Pub. No.: US 2025/0372079 A1
(43) Pub. Date: Dec. 4, 2025

(54) SPEECH SYNTHESIS APPARATUS AND METHOD FOR MULTILINGUAL AND MULTISPEAKER

(71) Applicants: HYUNDAI MOTOR COMPANY, Seoul (KR); KIA CORPORATION, Seoul (KR)

(72) Inventors: Sung Woong Hwang, Hwaseong-si (KR); Chang Hwan Kim, Hwaseong-si (KR)

(73) Assignees: HYUNDAI MOTOR COMPANY, Seoul (KR); KIA CORPORATION, Seoul (KR)

(21) Appl. No.: 18/960,288

(22) Filed: Nov. 26, 2024

(30) Foreign Application Priority Data
May 28, 2024 (KR) 10-2024-0069485

(51) Int. Cl. G10L 13/08; G10L 13/04

(52) U.S. Cl. CPC G10L 13/086; G10L 13/04

(57) ABSTRACT

A speech synthesis apparatus includes a memory configured to store language information set by a user and audio samples of a speaker selected by the user. The speech synthesis apparatus also includes a processor configured to generate audio signals corresponding to input text by applying a speech synthesis model to the input text, the language information, and the audio samples in response to a speech synthesis request of the user. The language information is different from a language related to the audio samples.

### CROSS-REFERENCE TO RELATED APPLICATION

This application claims the benefit of and priority to Korean Patent Application No. 10-2024-0069485, filed on May 28, 2024, the entire contents of which are hereby incorporated herein by reference.

### TECHNICAL FIELD

The present disclosure relates to an apparatus and a method for multilingual and multispeaker speech synthesis.

### BACKGROUND

The content described in this section merely provides background information related to the present disclosure and may not constitute prior art.

Recent advancements in speech synthesis have led to its widespread use in various fields, including voice guidance and education. Speech synthesis is a technology that generates sounds similar to human speech and is commonly known as Text To Speech (TTS) system. Speech synthesis technology delivers information to the user through speech signals rather than text or images, making it particularly useful when the user is unable to see the screen of a machine in operation, such as when the user is driving a car or when the user is blind. In recent years, development and distribution of smart home devices like artificial intelligence speakers, smart TVs, and smart refrigerators, as well as personal portable devices such as smartphones, e-book readers, and car navigation systems, have been actively pursued, leading to a rapid increase in the desire for speech synthesis techniques and devices for speech output.

Conventional speech synthesis methods include various methods such as unit selection synthesis (USS) and statistical parameter synthesis (HMM-based Speech Synthesis, HTS). The USS method segments and stores speech data into phoneme units and identifies and concatenates sound fragments suitable for speech synthesis; the HTS method extracts parameters corresponding to speech characteristics, generates a statistical model, and converts text into speech based on the statistical model.

Conventional speech synthesis methods include generating a spectrogram based on input text and generating a sound wave based on the spectrogram. Here, a spectrogram is a tool for visualizing and understanding a sound or a waveform. A spectrogram is obtained by converting an audio signal in the time domain into frequency components against the time domain axis. Based on the spectrogram, characteristics of a waveform and its spectrum may be visualized.

Furthermore, the speech synthesis method may generate sound waves that reflect speech characteristics of the speaker. The speech synthesis method may generate a speech signal corresponding to the input text based on the attributes such as the speaker's voice, prosody, pitch, and speech rate.

Recently, a speech synthesis method that uses artificial neural networks to generate speech from text has been gaining attention.

Nevertheless, it is difficult for conventional speech synthesis models to synthesize speech for unseen speaker-language combinations. Specifically, training data used to train a conventional speech synthesis model consists of [text, speaker, language]. Since most speakers may speak in one language, it is difficult for a speech synthesis model to naturally generate speech in another language for the same speaker. For example, a speech synthesis model trained based on speech data of a man speaking English has limitations in synthesizing speech data of the same man speaking Korean.

However, the conventional speech synthesis method described above has many limitations in synthesizing natural speech that reflects the speaker's speech style or emotional expression.

Moreover, in the fields where speech synthesis systems are applied, low-quality synthesized speech, such as speech with incorrect tone or intonation, is often used without correction; since single-speaker speech synthesis models generate the speech of only one speaker, their applications are limited to specific uses.

### SUMMARY

An object of the present disclosure is to provide a device and a method for synthesizing natural speech that gives an impression that a target speaker fluently speaks text in a target language even if audio data of the target speaker in the target language is sparse or absent.

The technical objects of the present disclosure are not limited to those described above. Other technical objects not mentioned above may be more clary understood by those having ordinary skill in the art from the description below.

According to an aspect of the present disclosure, a speech synthesis apparatus is provided. The speech synthesis apparatus includes a memory configured to store language information set by a user and audio samples of a speaker selected by the user. The speech synthesis apparatus also includes a processor configured to generate audio signals corresponding to input text by applying a speech synthesis model to the input text, the language information, and the audio samples in response to a speech synthesis request of the user, wherein the language information is different from a language related to the audio samples.

According to another aspect of the present disclosure, a speech synthesis method is provided. The speech synthesis method includes receiving a speech synthesis request for input text, wherein the speech synthesis request includes language information and speaker information set by a user. The speech synthesis method also includes generating audio signals corresponding to the input text by applying a speech synthesis model to the input text, the language information, and audio samples of the speaker information, wherein the language information is different from a language related to the audio samples.

According to embodiments of the present disclosure, natural speech may be synthesized that gives an impression that a target speaker fluently speaks text in a target language even if audio data of the target speaker in the target language is sparse or absent.

According to embodiments of the present disclosure, a vehicle occupant may receive a voice guidance synthesized based on the occupant's desired speaker and language.

The technical effects of the present disclosure are not limited to the technical effects described above. Other technical effects not mentioned herein may be understood by those having ordinary skill in the art to which the present disclosure pertains from the description below.

### BRIEF DESCRIPTION OF THE DRAWINGS

FIG. 1 illustrates the structure of a vehicle according to one embodiment of the present disclosure.

FIG. 2 illustrates a speech synthesis according to one embodiment of the present disclosure.

FIG. 3 illustrates training of a speech synthesis model according to one embodiment of the present disclosure.

FIG. 4 illustrates the operation of a speech synthesis model according to one embodiment of the present disclosure.

FIG. 5 is a flow diagram of a speech synthesis method according to one embodiment of the present disclosure.

### DETAILED DESCRIPTION

Hereinafter, embodiments of the present disclosure are described in detail with reference to the accompanying drawings. In the accompanying drawings, like reference numerals preferably designate like elements even when the elements are shown in different drawings. Further, in the following description, a detailed description of known functions and configurations incorporated therein has been omitted for the purpose of clarity and for brevity.

Various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude other components unless specifically stated to the contrary. Terms such as ‘unit’, ‘module’, and the like refer to one or more units for processing at least one function or operation, which may be implemented by hardware, software, or a combination thereof.

When a component, device, module, element, or the like of the present disclosure is described as having a purpose or performing an operation, function, or the like, the component, device, or element should be considered herein as being “configured to” meet that purpose or perform that operation or function.

The following detailed description, together with the accompanying drawings, is intended to describe example embodiments of the present disclosure, and is not intended to represent the only embodiments in which the present disclosure may be practiced.

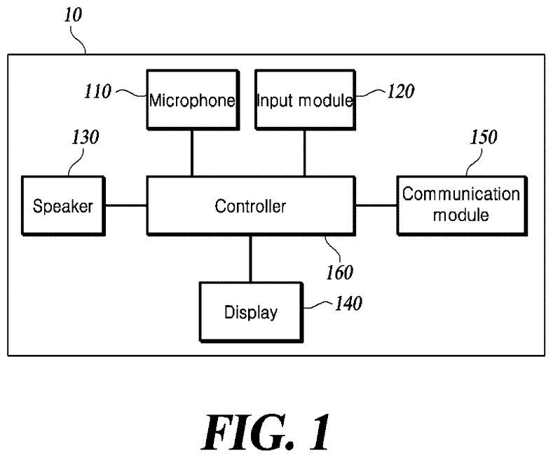

FIG. 1 illustrates the structure of a vehicle according to an embodiment of the present disclosure.

Referring to FIG. 1, a vehicle 10 includes a microphone 110 through which a user's voice is input, an input module 120 receiving vehicle information, a speaker 130 outputting a sound necessary for providing a service desired by the user, a display 140 displaying an image necessary for providing a service desired by the user, a communication module 150 performing communication with an external device, and a controller 160 controlling the constituting elements above and other constituting elements of the vehicle.

The microphone 110 may be provided at a location inside the vehicle 10 where the user's voice is input. The user who inputs voice into the microphone 110 provided in the vehicle 10 may be the driver. The microphone 110 may be installed at a location such as the steering wheel, center fascia, headlining, or rearview mirror to receive the driver's voice.

In addition to the user's voice, various audio sounds generated around the microphone 110 may be input to the microphone 110. The microphone 110 outputs an audio signal corresponding to the input audio signal. The output audio signal may be processed by the controller 160 or transmitted to an external server device through the communication module 150.

In addition to the microphone 110, the vehicle 10 may include the input module 120 for receiving user commands. The input module 120 may be provided in the form of a button or a jog shuttle in the cluster area, the AVN (Audio, Video, Navigation) area of the center fascia, the gearbox area, or the steering wheel.

Also, to receive control commands related to the passenger seat, the input module 120 may include an interface device provided on the door of each seat and an interface device provided on the armrest of the front seat or the armrest of the rear seat.

Also, the input module 120 may include a touch pad integrated with the display 140 to implement a touch screen.

Also, the input module 120 may include a camera. The camera may acquire at least one of an internal image or an external image of the vehicle 10. The camera may be installed inside, outside, or both inside and outside of the vehicle 10. The images collected by the camera are processed by the controller 160 or an external server device. Based on the collected images, the gaze, mouth shape, face, behavior, or state of the occupant in the video may be analyzed.

The speaker 130 outputs an electrical signal in the form of a sound wave. The speaker 130 may be disposed to face the inside of the vehicle 10 near each door, roof, front window, or rear window. The speaker 130 may refer to various types of speakers, such as loudspeakers and array speakers.

The display 140 may include an AVN display, a cluster display, or a head-up display (HUD) provided on the center fascia of the vehicle 10. Alternatively, the display 140 may include a rear seat display provided on the back of the headrest of the front seat for passengers in the rear seat. Alternatively, when the vehicle 10 is a multi-passenger vehicle, the display 140 may include a display mounted on the headlining.

The display 140 may be provided in locations where the occupants of the vehicle 10 may see it, and there are no other restrictions on the number or location of the displays 140.

The communication module 150 may exchange signals with other devices by employing at least one of various wireless communication methods such as Bluetooth, 4G communication, 5G communication, or Wi-Fi. Alternatively, the communication module 150 may exchange information with other devices through a cable connected to a Universal Serial Bus (USB) port, auxiliary (AUX) port, and so on.

Also, the communication module 150, by being equipped with two or more communication interfaces that support different communication methods, may exchange information signals with two or more other devices.

For example, the communication module 150 may communicate with a mobile device located inside the vehicle 10 through Bluetooth communication to receive information (user's video, voice, contact information, schedule, and so on) obtained by the mobile device or stored therein, transmit the user's voice by communicating with the server 1 through the 4G or 5G communication, and receive signals necessary to provide a service desired by the user. Also, the communication module 150 may exchange necessary signals with the server 1 through a mobile device connected to the vehicle 10.

In addition to the above, the vehicle 10 may include a navigation device for providing route guidance, an air conditioning device for controlling the internal temperature, a window control device for controlling opening/closing of windows, a seat heating device for warming up the seats, a seat positioning device for adjusting the position, height, or angle of the seats, and a lighting device for adjusting internal illumination.

The devices described above provide convenience functions related to the vehicle 10, and some of the devices may be omitted depending on the vehicle model and options. Also, it should be noted that other devices may be included in addition to the devices described above. For driving of the vehicle 10, well-known configurations are employed, and description thereof has been omitted from the present disclosure.

The controller 160 may turn on/off the microphone 110 and process or store the voice input to the microphone 110 and/or transmit the input voice to another device through the communication module 150.

Also, the controller 160 may control images to be displayed on the display 140 and control sounds to be output to the speaker 130.

Also, the controller 160 may perform various control operations related to the vehicle 10. For example, according to a user's command input through the microphone 110 or the input module 120, the controller 160 may control at least one of the navigation device, the air conditioning device, the window control device, the seat heating device, the seat positioning device, or the lighting device.

The controller 160 may include at least one memory that stores a program for performing the operation above as well as those described below. The controller 160 may also include at least one processor that executes the stored program.

According to an embodiment of the present disclosure, the controller 160 may operate as a speech synthesis device. For example, a user may request audio output so that the text displayed on the display 140 is spoken in a specified language by a selected speaker. The user's desired language and speaker may be set in advance. The controller 160 may synthesize speech corresponding to the text by converting the text into an audio signal based on the requested language and selected speaker. For example, a user may want to hear the English text “Directions to home will be provided” spoken in a Korean voice, e.g., the accent or intonation of a Korean speaker reading English. The controller 160 retrieves a pre-stored audio sample of the Korean voice and applies a speech synthesis model to the English text and the audio sample. The speech synthesis model generates audio signals that make the English text sound as if it is naturally spoken by a Korean voice. The audio signal is output through the speaker 130. The user may hear the English text spoken naturally by a selected Korean speaker.

In another example, the controller 160 may synthesize and convert the user's voice or text according to a different speaker and language.

According to another embodiment, the controller 160 and the communication module 150 may provide a speech synthesis function in conjunction with an electronic device located outside the vehicle 10.

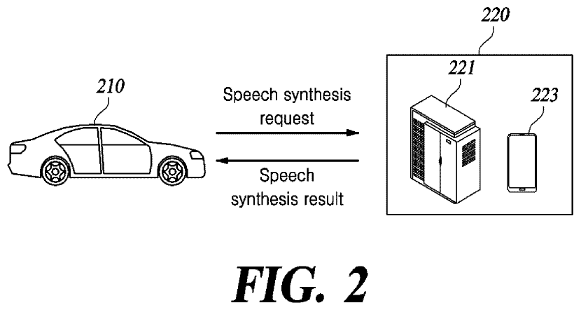

FIG. 2 illustrates a speech synthesis according to an embodiment of the present disclosure.

Referring to FIG. 2, the speech synthesis system includes a vehicle 210 and an electronic device 220. The speech synthesis method may be implemented by the vehicle 210 and the electronic device 220. The speech synthesis model may be implemented on the electronic device 220, and the speech synthesis method may be performed by the electronic device 220.

The electronic device 220 may perform speech synthesis. The electronic device 220 may be implemented by at least one of a server device 221 or a mobile terminal 223.

The vehicle 210 may transmit a speech synthesis request to the electronic device 220, and the electronic device 220 may respond to the vehicle 210 with an audio signal, which is the speech synthesis result. The speech synthesis request includes text to be synthesized into a speech, language information for the text, and speaker information.

In an embodiment, the vehicle 210 transmits a speech synthesis request including a set consisting of [text, speaker] or [text, speaker, language] pairs to the electronic device 220. The electronic device 220 generates an audio signal indicating that the requested text is spoken by a selected speaker. Since it is not the case that an actual speaker utters the text, the audio signal is generated data rather than recorded data. However, the audio signal may contain natural pronunciation and voice, as if it were a recording of an actual speaker speaking fluently in a requested language. The electronic device 220 transmits the generated audio signal as a result of speech synthesis to the vehicle 210. The vehicle 210 may reproduce the received audio signal, thereby outputting the audio signal according to the text, speaker, and language requested by the user.

In an embodiment, the electronic device 220 may include a processor and a memory for speech synthesis.

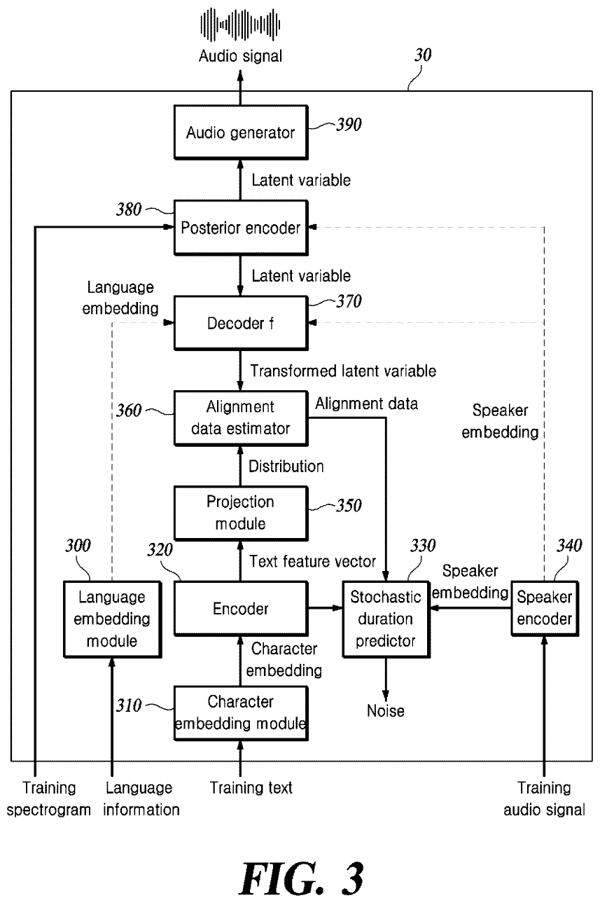

FIG. 3 illustrates training of a speech synthesis model according to an embodiment of the present disclosure.

Referring to FIG. 3, a model architecture 30 specifying the training stage of a speech synthesis model is shown. In the training stage, the model architecture 30 includes a language embedding model 300, character embedding model 310, an encoder 320, a stochastic duration predictor 330, a speaker encoder 340, a projection module 350, an alignment data estimator 360, a decoder 370, a posterior encoder 380, and an audio generator 390. In another embodiment, part of the constituting elements included in the model architecture 30 may be omitted, or the order of the constituting elements may be changed. The model architecture 30 may further include a discriminator. However, the discriminator is not shown in the figure. The posterior encoder 380 and the discriminator are used only for the training of the speech synthesis model.

In FIG. 3, the dashed arrow indicates global conditioning. In the present disclosure, conditioning of embeddings may refer to adding, multiplying, or subtracting embeddings to or from the input or within. To ensure dimensionality matching, the convolutional layer may adjust the dimension of the embeddings. For example, within the decoder 370, speaker embeddings may be incorporated into latent variables.

For training of the speech synthesis model, a training data set is prepared in advance. The training data set includes text data, audio data corresponding to text data, and language data. Audio data comprises recordings of text data actually spoken by multiple speakers. Training data may be represented as triplets consisting of [training text, speaker's audio signal for training, language]. However, since most speakers are proficient in only a few languages, training data consisting of [text, speaker's audio signal, and language] triplets may be sparse. In other words, multispeaker-multilingual datasets may be sparse.

The training text may include a sequence of characters in a natural language. For example, a sequence of characters may include alphabetic characters, numbers, punctuation marks, or other special characters.

Training audio signals represent speech data of speakers. The training audio signal includes the speaker's voice and/or speech characteristics. A speaker's speech characteristics may include at least one of various elements such as speech speed, pause intervals, pitch, tone, prosody, intonation, pronunciation, or emotion. Multi-speaker audio signals are then prepared.

Furthermore, linear-spectrograms or Mel-spectrograms converted from the speaker's audio signals may be prepared in advance to be used as training data. Linear-spectrograms may be generated by applying the short-time Fourier transform (STFT), discrete Fourier transform (DFT), or fast Fourier transform (FFT) to the speaker's speech signal. A Mel-spectrogram is obtained by adjusting the frequency interval of the linear-spectrogram to the Mel-scale. The Mel-spectrogram may be obtained by applying a Mel-filterbank to the linear spectrogram.

Language information indicates the language of text data. Language information may be represented numerically. For example, language information may include Korean, English, German, Japanese, Chinese, and so on. Korean may be displayed as 1, English as 2, and German as 3.

FIG. 3 illustrates a process in which training text, training audio signals, training spectrograms, and language information within the training dataset are processed for training.

The speaker encoder 340 transforms or maps the speaker's training audio signal into speaker embeddings. Speaker embeddings represent the speaker's speech characteristics and may be expressed in a vector form. Also, speaker embedding may include speaker identification information.

The speaker encoder 340 may represent discontinuous data values included in speaker information as a vector composed of consecutive numbers. For example, the speaker encoder 340 may generate a speaker embedding vector based on a combination of at least one or two or more of various artificial neural network models, including a pre-net, a CBHG module, a deep neural network (DNN), a convolutional neural network (CNN), a recurrent neural network (RNN), a long short-term memory network (LSTM), and a Bidirectional Recurrent Deep Neural Network (BRDNN).

The language embedding module 300 transforms language information corresponding to the training text into language embeddings. For example, the language embedding module 300 may map language information to language embeddings using one-hot encoding. Language embeddings may be in a vector form. Since one-hot encoding is a widely known technology in the field of speech synthesis, detailed descriptions thereof has been omitted.

The character embedding module 310 transforms or maps training text into character embeddings. For example, training text may be composed in sentence or character units. The character embedding module 310 may separate the training text into character units and transform each separated text into character embeddings. Alternatively, the character embedding module 310 may separate the training text into alphabet units or phoneme units and then transform them into character embeddings. For example, the text embedding module 310 may perform text embedding using an artificial neural network model. Character embeddings may be represented as learnable vectors.

The encoder 320 extracts text feature vectors from character embeddings. Text feature vectors extracted by the encoder 320 include character embeddings, i.e., features of the training text.

In one embodiment, the encoder 320 may perform encoding in phoneme units. To this end, the encoder 320 may separate the character embeddings into phoneme units of the training text. In another embodiment, the encoder 320 may perform encoding on the entire set of character embeddings.

The encoder 320 may be an artificial neural network. For example, the encoder 320 may be a transform-based encoder 320. The transform-based encoder 320 includes a plurality of transformer blocks, and each transformer block includes at least one encoder 320, at least one decoder, and an attention module. For example, the transform-based encoder 320 may include 10 transformer blocks. The transformer block extracts context vectors from character embeddings using the encoder 320, identifies important character embeddings using the attention module, and generates text feature vectors from a context vector and the outputs of the attention module using the decoder 370.

The projection module 350 outputs the distribution of text feature vectors to match dimensions before element-wise summation. Here, the distribution of text feature vectors may be a prior distribution including the means and standard deviations of the text feature vectors. The distribution may include the mean and standard deviation of each text feature vector corresponding to each phoneme. The projection module 350 may be a linear projection layer.

The posterior encoder 380 encodes training spectrograms and outputs latent variables. Encoding means extracting features from existing data and transforming them into data with reduced size or dimensionality compared to existing data. In other words, the result output through encoding may be the result obtained by compression of the input data. The latent variable may be a latent vector. Latent variables include the speaker's voice and/or speech characteristics.

Here, the training spectrograms may be linear-scale spectrograms or mel-spectrograms transformed from the speaker's training audio signal. In another embodiment, an audio file format such as wav or mp3 is input to the posterior encoder 380, and the posterior encoder 380 may encode the audio signal to extract a latent vector.

The posterior encoder 380 may further employ the speaker embedding to output latent variables. In other words, the posterior encoder 380 may receive the training spectrogram and speaker embedding and extract latent variables from the training spectrogram and speaker embedding. Speaker embeddings may be used for global conditioning. For example, speaker embeddings may be added to the training spectrograms or latent variables. The conditioned latent variables include the features of the training spectrograms and speaker embeddings.

The posterior encoder 380 may be a deep neural network. For example, the posterior encoder 380 may be a Variational Auto-Encoder (VAE) encoder. The posterior encoder 380 may include non-causal WaveNet residual blocks used in the WaveGlow model and the Glow-TTS model. For example, the posterior encoder 380 may include 12 wavenet residual blocks. The non-causal WaveNet residual block consists of an extended convolutional layer with gated activation units and skip connections. A linear projection layer on top of the block generates the mean and variance of the normal posterior distribution.

The decoder 370 outputs transformed latent variables based on the latent variables, language embeddings, and speaker embeddings. The decoder 370 may generate a latent variable having a distribution different from the prior distribution of the latent variable. Here, the different distribution may be a normal distribution.

The decoder 370 may use the speaker embeddings as conditioning information. For example, the decoder 370 may condition the speaker embeddings on the input or output of the decoder 370 by adding or multiplying the speaker embeddings to the latent variables or the transformed latent variables.

Furthermore, the decoder 370 may remove language information from the latent variables. In an embodiment, the decoder 370 receives language embeddings corresponding to training text. The decoder 370 may remove language-related features within the latent variables by normalizing the language information of the latent variables. For example, removal of language information may be performed based on Eq. 1.

$$LN ( x , g ) = \frac{x - m ( g )}{{e}^{v ( g )}} \qquad [ Eq . 1 ]$$

In Eq. 1, LN(x, g) represents the result of language normalization, x is a conditioning target, which may be a latent variable or a latent variable obtained through conditioning of speaker embeddings, g represents language embeddings, m(g) represents the mean of the language embeddings, and v(g) represents the variance of the language embeddings. Language normalization may be applied to a portion of dimensionality of the latent variable.

As described above, the decoder 370 may condition the latent variables and the speaker embeddings, may normalize language-related features within the latent variables conditioned based on the language embeddings, and may generate the transformed latent variables by sampling the variables from a distribution simpler or more complex than the distribution of the preprocessed latent variable. Here, preprocessing refers to conditioning of speaker embeddings and normalization of language embeddings. The decoder 370 may remove language information of the training text in the conditioned latent variables by normalizing the latent variable conditioned by language embeddings. The transformed latent variable includes features of training audio signals and may not include language information of the training text.

The decoder 370 may be a normalizing flow function. The decoder 370 may obtain a transformed latent variable by applying the function ƒ to the preprocessed latent variable. Since the distribution transformation of the decoder 370 is reversible, an inverse function exists for the decoder ƒ. The transformed latent variable may have the same, a different, or a more complex distribution compared to the original latent variable. Here, a complex distribution refers to the one with multiple local minima and maxima, unlike a simple normal distribution.

The decoder 370 may be a deep neural network. For example, the decoder 370 may be a flow-based decoder. The decoder 370 includes a plurality of affine coupling layers. For example, the decoder 370 includes four affine coupling layers. A portion of affine coupling layers may be used for application of speaker embeddings, while the other affine coupling layers may be used for exclusion of language embeddings.

The affine coupling layer for removal of language information is referred to as a language normalized affine coupling layer. The language normalized affine coupling layer may perform language normalization by subtracting the mean of the language embeddings from the latent variable and dividing the subtraction result by the variance of the language embeddings. In one embodiment, an affine coupling layer may generate output by applying language normalization to a subset of the dimensions of the latent variable, applying an affine transformation based on scale and bias to the normalization result, and combining the transformation result with the remaining dimensions. The affine coupling layer is easily invertible and has a triangular Jacobian matrix, thereby facilitating efficient calculation of the determinant and the model density q.

As described above, the decoder 370 may generate the transformed latent variable conditioned by the speaker embeddings and normalized by the language embeddings.

The alignment data estimator 360 outputs alignment data based on the distribution of text feature vectors and transformed latent variables.

In an embodiment, the alignment data estimator 360 estimates a matrix for sorting the duration of each phoneme of the training text based on the mean values, standard deviation values, and transformed latent variables of the text feature vectors as alignment data. The alignment data's dimensionality depends on the length of the latent variable and the length of the character embedding. For example, rows may represent phonemes, while columns may represent time intervals. In the alignment data, the duration of each phoneme is expressed in the form of a path; elements along the path have a value of 1, while other elements have a value of 0. In other words, alignment data refers to alignment information between phonemes of training text and their respective latent variables.

To estimate matrix A, which is the alignment data between phonemes included in the training text, Monotonic Alignment Search (MAS), a method of searching for alignment that maximizes the likelihood of data parameterized by a flow normalization function, may be used. The alignment data estimator 360 may estimate alignment data by applying the MAS method to the distribution of text feature vectors and transformed latent variables. Since the MAS method is a widely known method, detailed descriptions thereof has been omitted.

The alignment data is used to train the stochastic duration predictor 330. The alignment data may refer to the similarity between text feature vectors and the transformed latent variable.

The stochastic duration predictor 330 receives text feature vectors, alignment data, and speaker embeddings, and, based on the received input, predicts the duration of each phoneme in the training text. In other words, the stochastic duration predictor 330 may predict phoneme duration data.

The stochastic duration predictor 330 may use speaker embeddings as conditioning information. The stochastic duration predictor 330 may condition speaker embeddings during the calculation process. For example, speaker embeddings may be added or multiplied to text feature vectors or alignment data.

The stochastic duration predictor 330 may be a flow-based generative model trained through maximum likelihood estimation. Meanwhile, noise may be calculated during the process of predicting phoneme length data.

The audio generator 390 generates an audio signal in the time domain based on latent variables. In other words, the audio generator 390 may generate a speech waveform based on the prior distribution of latent variables.

The audio generator 390 may be a deep neural network. The audio generator 390 may be a vocoder. For example, the audio generator 390 may be a HiFi-GAN generator. The audio generator 390 may consist of a stack of transposed convolutions, each convolution possibly followed by a multi-receptive field fusion (MRF) module. The output of MRF is a sum of the outputs of ‘residual blocks’ with varying receptive field sizes. The audio generator 390 may include a linear layer responsible for transforming speaker embeddings, adds the speaker embeddings to the latent variable z, and generates an audio signal from the combination of the latent variable and the speaker embeddings.

End-to-end training may be applied to the architecture 30 of the speech synthesis model described above. The architecture 30 of the speech synthesis model may be trained by a computer-implemented training device. A discriminator may be used for training of the audio generator 390. The discriminator may be the HiFi-discriminator.

In one embodiment, as a loss function of the speech synthesis model, at least one of reconstruction loss, Kullback-Leibler divergence loss, duration loss, adversarial loss, and feature matching loss may be used.

The reconstruction loss is calculated based on the difference between the spectrogram for the generated audio signal and the training spectrogram. A converter may be additionally used to convert the generated audio signal into a first spectrogram.

The KL divergence loss is calculated based on the difference between the latent variable and the text feature vectors. The KL divergence loss may be calculated based on the difference between the posterior probability of the latent variable and the conditional prior probability for the text feature vector. In other words, KL divergence loss may refer to the similarity between the distribution of the latent variable and the distribution of the text feature vector.

The duration loss is calculated based on the difference between the phoneme duration data predicted by the stochastic duration predictor 330 and the label of the phoneme duration data. The label of phoneme duration data refers to the utterance duration of each phoneme in the audio sample actually recorded by the speaker. Duration loss may be calculated based on the Mean Square Error (MSE). The duration loss is intended to enable the stochastic duration predictor 330 to predict the duration of each phoneme uttered by a conditioned speaker. The duration loss may be referred to as the lower bound on the variance of the log-likelihood of a phoneme sequence.

The adversarial loss is calculated based on the discriminator's determination on whether an audio signal generated by the audio generator 390 is genuine. To reduce the adversarial loss, it is necessary for the discriminator to determine the generated audio signal as genuine data. The adversarial loss causes the discriminator to output a value of 1 in response to an input of real data and to output a value of 0 in response to an input of fake data. The feature matching loss is calculated based on the difference between features extracted by the discriminator from the generated audio signal and features extracted by the discriminator from the actual audio signal.

Through training based on the adversarial loss and feature matching loss, the audio generator 390 may generate audio signals almost identical to actual data.

The loss function of the model architecture 30 may further include speaker consistency loss (SCL). Speaker consistency loss is calculated based on the difference between the output of the speaker encoder 340 and the ground-truth. In other embodiments, the speaker encoder 340 may be pre-trained.

In another embodiment, the reconstruction loss alone may be used as a loss function. Through end-to-end learning, model architecture 30 may be updated based on the difference between audio signals generated by the model architecture 30 from training text and labeled audio samples corresponding to the training text.

The model architecture 30 is updated in the direction that decreases the loss function above. Through iterative training based on the overall loss function, each component of the model architecture 30 is refined, enabling the speech synthesis model to generate natural speech signals of the speaker.

Through the training process described above, the speech synthesis model becomes robust to linguistic diversity. A speaker's dependency on a specific language is reduced. In other words, the speech synthesis model is trained based on text and speakers rather than specific languages. However, during the inference stage, the speech synthesis model utilizes linguistic information. Even if the speech synthesis model receives text in an unseen language, the speech synthesis model may generate a speaker's natural speech from the text using the information on the unseen language. For example, even if the training dataset is primarily composed of [Korean text, Korean voice] pairs with little instances of [Korean text, American voice] pairs, the speech synthesis model learns the meaning of the Korean text and captures speech characteristics of Americans without linguistic information. Afterwards, during the inference stage, the speech synthesis model may synthesize natural speech by incorporating Korean embeddings to [Korean text, American voice] data.

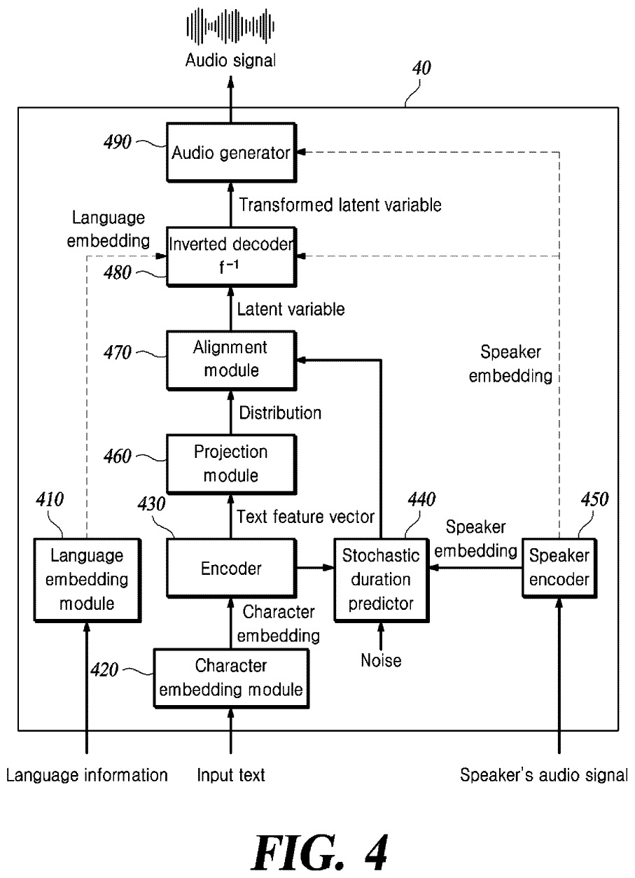

FIG. 4 illustrates the operation of a speech synthesis model according to an embodiment of the present disclosure.

Referring to FIG. 4, the configurations of the speech synthesis model 40 are shown. The speech synthesis model 40 may generate an audio signal as if the input text in a given language were spoken by a specific speaker. For example, the speech synthesis device stores language information set by the user and pre-recorded audio samples of a selected speaker. The content of the audio samples may differ from that of the input text. The speech synthesis device may synthesize an audio signal by applying the speech synthesis model to language information, the speaker's audio signals, and the target text.

In the inference stage, the speech synthesis model 40 includes a language embedding module 410, a character embedding module 420, an encoder 430, a stochastic duration predictor 440, a speaker encoder 450, and a projection module 460, an alignment module 470, an inverted decoder 480, and an audio generator 490.

The speech synthesis model 40 is trained by the method of FIG. 3. The language embedding module 410, character embedding module 420, encoder 430, stochastic duration predictor 440, speaker encoder 450, projection module 460, inverted decoder 480, and audio generator 490 of FIG. 4 correspond to the language embedding module 300, character embedding module 310, encoder 320, stochastic duration predictor 330, speaker encoder 340, projection module 350, and decoder 370 of FIG. 3. The inverted decoder 480 represents the inverse function of the decoder.

The language embedding module 410 converts the language information of input text into language embeddings. In one embodiment, the language embedding module 410 may be omitted, and language embeddings corresponding to various languages may be stored in advance. In other words, language embeddings corresponding to the language information of the input text are pre-stored, and the inverted decoder 480 may receive the language embeddings.

The character embedding module 420 converts given input text into character embeddings. The input text is mapped to a variable space for character embeddings.

The encoder 430 outputs text feature vectors for the input text by encoding character embeddings. Text feature vectors include features of each phoneme of the input text.

The speaker encoder 450 receives an audio signal recording the voice of a selected speaker and outputs speaker embeddings by encoding the audio signal. Speaker embeddings include the speaker's voice and/or speech characteristics.

The stochastic duration predictor 440 predicts the duration of each phoneme of the input text based on text feature vectors and speaker embeddings and outputs phoneme duration data including the duration of the phonemes. The phoneme duration data includes predicted duration for each phoneme based on the speaker's voice and/or speech characteristics. The phoneme duration data is input to the alignment module 470.

The projection module 460 generates the distribution of text feature vectors. The distribution of text feature vectors includes means and standard deviations of the text feature vectors. In this process, the text feature vector is transformed to match the dimensionality of the alignment data of the alignment module 470. The dimensionality of data representing the distribution may correspond to one of the dimensions of the alignment data.

The alignment module 470 generates latent variables based on the distribution of text feature vectors and phoneme duration data. Latent variables are generated from text feature vectors based on the phoneme duration data. For example, the alignment module 470 may calculate the mean and standard deviation of text feature vectors corresponding to each phoneme using the alignment data and output latent variables as a result of calculation. Latent variables may include features of each phoneme of the input text and features related to the duration of each phoneme.

The inverted decoder 480 generates transformed latent variables based on the latent variables, language embeddings, and speaker embeddings. The inverted decoder 480 may condition the language embeddings and the speaker embeddings on the latent variable, thereby transforming the latent variable into a variable having a prior distribution different from that of the original latent variable. In the conditioning process, language embeddings and speaker embeddings may be added or multiplied to latent variables. Since the inverted decoder 480 is trained for language normalization to exclude language information during the training stage, language embeddings have to be incorporated into the latent variables during the inference stage.

A portion of affine coupling layers within the inverted decoder 480 is used for denormalization of language embeddings. The aforementioned affine coupling layer may be referred to as a language denormalized affine coupling layer. For example, language embeddings may be incorporated into the latent variables based on Eq. 2.

$$LDN ( x , g ) = x \cdot exp ( v ( g ) ) + m ( g ) \qquad [ Eq . 2 ]$$

In Eq. 2, LDN(x, g) represents the result of language denormalization, x is a conditioning target, which may be a latent variable or a latent variable obtained through conditioning of speaker embeddings, g represents language embeddings, m(g) represents the mean of the language embeddings, and v(g) represents the variance of the language embeddings. Language denormalization may be applied to a portion of dimensionality of the latent variable. The result of language denormalization includes characteristics of the specific language g. According to Eq. 2, features of language embeddings may be incorporated into the latent variable or the latent variable obtained through conditioning of speaker embeddings.

Other affine coupling layers in the inverted decoder 480 are used for the application of speaker embeddings. These affine coupling layers apply speaker embeddings as conditioning information for latent variables or intermediate calculations of the latent variables. For example, speaker embeddings may be added or multiplied to the latent variables.

The inverted decoder 480 transforms the latent variables conditioned by the language embeddings and speaker embeddings. The inverted decoder 480 may obtain a transformed latent variable by applying the inverse function f−1 of a normalizing flow function used in the training stage to the latent variable. The transformed latent variable may have a simpler or more complex distribution than the conditioned latent variable. The inverted decoder 480 may transform the distribution of the latent variable based on the speaker embeddings and language embeddings. The transformed latent variable includes features of the input text, features of linguistic information, features of the speaker's audio signals, and duration features.

The audio generator 490 generates an audio signal representing a sound wave from the transformed latent variable and speaker embeddings. The speaker embeddings are incorporated into the transformed latent variables by conditioning. The audio generator 490 may generate an audio signal from the latent variables conditioned by the speaker embeddings. Specifically, the audio generator 490 may predict the audio signal from the distribution of the conditioned latent variables. The generated audio signal may be identical or similar to the audio recording of the speaker selected by the user uttering the input text. Even if the specific speaker is unfamiliar with the language of the input text, a result may be generated as if the specific speaker has uttered the input text in that language.

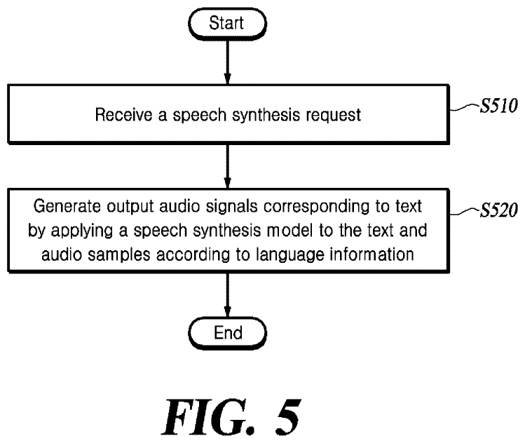

FIG. 5 is a flow diagram of a speech synthesis method according to an embodiment of the present disclosure.

Referring to FIG. 5, in an operation S510, the speech synthesis device receives a speech synthesis request from the user.

Here, the speech synthesis request includes text to be synthesized into speech. In one embodiment, the speech synthesis request may include speaker information and language information desired by the user. In another embodiment, speaker information and language information are set by the user in advance, and the speech synthesis device may store the set information in advance. Also, the speech synthesis device stores audio samples of speakers in advance. However, audio samples in the requested language for a requested speaker may not be available. In other words, the language information of the requested text may be different from the language of the requested speaker's audio samples.

Nevertheless, in an operation S520, the speech synthesis device applies the speech synthesis model to text and audio samples according to the language information and generates output audio signals corresponding to the text.

Here, the speech synthesis model is trained to generate an audio signal that includes features of the training text and features of the training audio signals, but with the language information of the training text removed. In the training stage, the speech synthesis model may remove the language information of the training text by normalizing the training latent variables, which include the features of the training text and the features of the training audio signals, using the language information of the training text.

In the inference stage, the speech synthesis model includes a language embedding module, a character embedding module, an encoder, a speaker encoder, a stochastic duration predictor, a projection module, an alignment module, an inverted decoder, and an audio generator.

The language embedding module transforms the requested language information into language embeddings. In other embodiments, language embeddings may be pre-stored, and the language embedding module may not be included in the speech synthesis model.

The character embedding module transforms input text into character embeddings.

The encoder encodes character embeddings into text feature vectors.

The speaker encoder encodes audio samples to output speaker embeddings.

The stochastic duration predictor predicts phoneme duration data that includes duration of each phoneme of the input text based on the text feature vectors and the speaker embeddings.

The projection module generates a distribution of the text feature vectors. Here, the distribution includes the mean and standard deviation.

The alignment module generates latent variables based on the distribution of the text feature vectors and phoneme duration data.

The inverted decoder outputs transformed latent variables based on the latent variables, language embeddings, and speaker embeddings. Specifically, the inverted decoder conditions the latent variables on the speaker embeddings and language embeddings and outputs latent variables transformed based on the conditioned latent variables.

The audio generator generates audio signals from the transformed latent variables. The audio generator may condition the transformed latent variables using the speaker embeddings and generate audio signals from the conditioned latent variables.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in the present disclosure as being sequentially performed, this is merely an illustrative description of the technical idea of the present disclosure. In other words, those having ordinary skill in the art to which the present disclosure pertains should appreciate that various modifications and changes can be made without departing from essential features of the present disclosure. For example, the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present disclosure is not limited by the illustrations. Accordingly, one of ordinary skill in the art should understand that the scope of the present disclosure is not limited by the above explicitly described embodiments but by the appended claims and equivalents thereof.

What is claimed is:

1. A speech synthesis apparatus comprising:
a memory configured to store language information set by a user and audio samples of a speaker selected by the user; and
a processor configured to generate audio signals corresponding to input text by applying a speech synthesis model to the input text, the language information, and the audio samples in response to a speech synthesis request of the user,
wherein the language information is different from a language related to the audio samples.

2. The speech synthesis apparatus of claim 1, wherein the speech synthesis model is trained to generate audio signals from which language information of training text is removed,
wherein the audio signals include features of the training text and features of training audio signals.

3. The speech synthesis apparatus of claim 2, wherein the speech synthesis model is configured to remove language information of the training text by normalizing training latent variables, that include the features of the training text and the features of the training audio signals, using language information of the training text.

4. The speech synthesis apparatus of claim 1, wherein the speech synthesis model comprises:
a language embedding module configured to transform the language information into a language embedding;
a character embedding module configured to transform the input text into character embeddings;
an encoder configured to encode the character embeddings into text feature vectors;
a speaker encoder configured to encode the audio samples and output a speaker embedding;
a stochastic duration predictor configured to predict phoneme duration data including duration of each phoneme of the input text based on the text feature vectors and the speaker embedding;
a projection module configured to generate a distribution of the text feature vectors;
an alignment module configured to generate a latent variable based on the distribution of the text feature vectors and the phoneme duration data;
an inverted decoder configured to output a latent variable transformed based on the latent variable, the speaker embedding, and the language embedding; and
an audio generator configured to generate the audio signals from the transformed latent variable.

5. The speech synthesis apparatus of claim 4, wherein the inverted decoder is configured to:
condition the latent variable on the speaker embedding and the language embedding; and
output the transformed latent variable based on the conditioned latent variable.

6. The speech synthesis apparatus of claim 4, wherein the audio generator is configured to:
condition the transformed latent variable on the speaker embedding; and
generate the audio signals from the conditioned latent variable.

7. A speech synthesis method comprising:
receiving a speech synthesis request for input text, wherein the speech synthesis request includes language information and speaker information set by a user; and
generating audio signals corresponding to the input text by applying a speech synthesis model to the input text, the language information, and audio samples of the speaker information,
wherein the language information is different from a language related to the audio samples.

8. The speech synthesis method of claim 7, wherein the speech synthesis model is trained to generate audio signals from which language information of training text is removed, and wherein the audio signals include features of the training text and features of training audio signals.

9. The speech synthesis method of claim 8, wherein generating the audio signals corresponding to the input text by applying the speech synthesis model includes removing language information of the training text by normalizing training latent variables, that include the features of the training text and the features of the training audio signals, using language information of the training text.

10. The speech synthesis method of claim 7, wherein generating the audio signals corresponding to the input text by applying the speech synthesis model includes:
transforming, by a language embedding module, the language information into a language embedding;
transforming, by a character embedding module, the input text into character embeddings;
encoding, by an encoder, the character embeddings into text feature vectors;
encoding, by a speaker encoder, the audio samples and outputting a speaker embedding;
predicting, by a stochastic duration predictor, phoneme duration data including duration of each phoneme of the input text based on the text feature vectors and the speaker embedding;
generating, by a projection module, a distribution of the text feature vectors;
generating, by an alignment module, a latent variable based on the distribution of the text feature vectors and the phoneme duration data;
outputting, by an inverted decoder, a latent variable transformed based on the latent variable, the speaker embedding, and the language embedding; and
generating, by an audio generator, the audio signals from the transformed latent variable.

11. The speech synthesis method of claim 10, wherein outputting the latent variable includes:
conditioning, by the inverted decoder, the latent variable on the speaker embedding and the language embedding; and
outputting, by the inverted decoder, the transformed latent variable based on the conditioned latent variable.

12. The speech synthesis method of claim 10, wherein generating the audio signals includes:
conditioning, by the audio generator, the transformed latent variable on the speaker embedding; and
generating, by the audio generator, the audio signals from the conditioned latent variable.
